(19) United States
(12) Patent Application Publication
(10) Pub. No.: US 2012/0106910 A1
(43) Pub. Date: May 3, 2012

(54) HOUSING FOR GLASS FIBER-BASED LIGHTWAVE CONDUCTORS

(75) Inventor: Franz Koller, Germering (DE)

(73) Assignee: NOKIA SIEMENS NETWORKS GMBH & CO. KG, MUENCHEN (DE)

(21) Appl. No.: 12/994,049

(22) PCT Filed: Jul. 16, 2010
(86) PCT No.: PCT/EP2010/060336

§ 371 Date: Mar. 24, 2011

(30) Foreign Application Priority Data
Jul. 21, 2009 (DE) 20 2009 009 985.7

(51) Int. Cl. G02B 6/00

(52) U.S. Cl. 385/134

(57) ABSTRACT

An optical waveguide housing and method for tension-free accommodation of optical waveguides in a spool housing, in which the emerging fiber length can be easily adapted by simple means.

The invention relates to a housing for glass-fiber-based optical waveguides.

Optical transmission systems are typically composed of a plurality of components, for example assemblies for optical interfaces, optical coupling elements, transponders and, not least, optical amplifiers. Optical amplifiers may, for example, be erbium-doped fiber amplifiers (EDFA=erbium-doped fiber amplifier). An EDFA essentially comprises a high-power pump laser and an erbium-doped fiber in which the pump light is converted to signal light. The required amplification in this case depends on a number of factors, such as the pump light, the doping of the fiber and, in particular, the length of the fiber. Different fiber lengths are required, depending on the application.

In conventional systems, amplifier fibers have normally been rolled manually onto special winding mandrels. This process is time-consuming, since, in C-band, the fibers may have a length of up to 300 m. Furthermore, the manual winding can result in the fiber being inadvertently tensioned. In addition, there are in general remaining lengths, if the fiber length does not result in a precise multiple of the circumference of a winding spool. In consequence, this leads to loose fibers which can hang out freely and can thus cause disturbances or, for example, may lie on hot components, which can lead to adverse effects on operation.

The object of the invention is to avoid the disadvantages mentioned above and to allow the fiber to be accommodated efficiently on or in a housing.

This object is achieved according to the features of the independent patent claim. Developments of the invention also result from the dependent claims.

In order to achieve the object, a housing is specified for optical waveguides, wherein the housing has a winding slot. The winding slot is used to hold optical waveguides, for example amplifier fibers or dispersion compensation fibers. The advantage is that the fibers can be stowed in an organized manner.

The housing with the winding slot may also have a spacing bolt hole for a removable spacing bolt. The spacing bolt hole can be used to hold a bolt.

The spacing bolt hole for holding a spacing bolt may in this case be fitted in the housing such that a bolt which has been inserted into the spacing bolt hole projects into the winding slot. The inserted spacing bolt results in a larger spool radius at this point in the winding slot.

In one development, the optical waveguide can be wound up in the winding slot, essentially without any pressure or tension. In particular, this can be achieved by the fiber being wound flush with the inserted spacing bolt onto the spool. After the spacing bolt has been removed, this results in the fiber winding being located loosely, with the optical waveguide being wound in the winding slot, essentially without any pressure and tension.

The tension-free fiber winding therefore allows the fiber length to be adapted easily simply by pulling the fiber tight or conversely by pushing the fiber back into the winding slot. This results in the fiber being wound without any remaining length, and without major effort.

Furthermore, the winding slot is provided with a slot cover which is used to cover the winding slot.

The slot prevents the—frequently unwieldy—fiber from being unrolled. In this case, the slot cover may be in the form of a clamping ring which, by virtue of its design, can be locked on the winding housing. The loose winding up of the fiber allows the length of the fiber to be kept variable within certain limits, since it can easily be pushed into the winding slot, or can be pulled out again. This allows residual lengths or excess lengths, which have a disturbing effect, to be avoided. In this case, it should be noted that disturbing residual lengths essentially relate to those residual lengths which could interfere with or adversely affect the operation of the appliance. The housing and the clamping ring will be formed integrally. It is advantageous that a connection between the housing and the clamping ring can prevent the clamping ring from being lost. From the logistics point of view, the integral production ensures that a clamping ring is also available for each housing. From the manufacturing point of view, it is advantageous for it to be possible to manufacture both the housing and clamping ring in one process (for example by injection molding). In another development, the housing has a hole, which is incorporated essentially centrally in the base area of the housing and can act as a hub. This hub can be used for plugging the housing onto a shaft. The capability to plug the housing onto a shaft is advantageous in manufacture, for example when several hundred meters of a fiber are intended to be wound up onto the spring housing by machine.

One additional development is for the hub in the housing also to have an outward drive bulge for rotation of the housing. This is advantageous for machine winding of the fiber onto the housing, since a shaft with a correspondingly designed drive apparatus can then at the same time be used as a drive. This leads to a significant time saving during manufacture. Furthermore, the spool housing may have at least one side fiber outlet opening for guiding the optical waveguide. The fibers can be passed out of the winding slot through one or more fiber outlet openings.

Because of the locking capability, the clamping ring can be arranged such that the cutouts on the clamping ring are located directly above the fiber outlet openings of the spool body. This has the advantage that the fiber cannot be trapped.

In another refinement, the housing has at least one mounting capability, for example at least one mounting hole. This advantageously results in numerous possible ways to mount the housing at different points in the appliance or on an assembly.

Exemplary embodiments of the invention will be explained with reference to, and in particular are illustrated schematically in, the following figures:

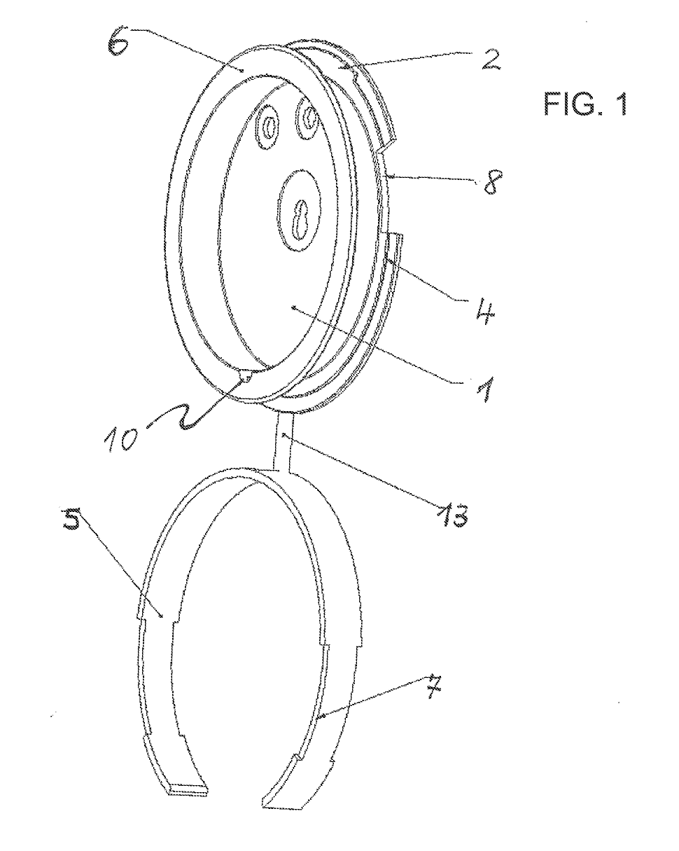

FIG. 1 shows a perspective view of a housing,

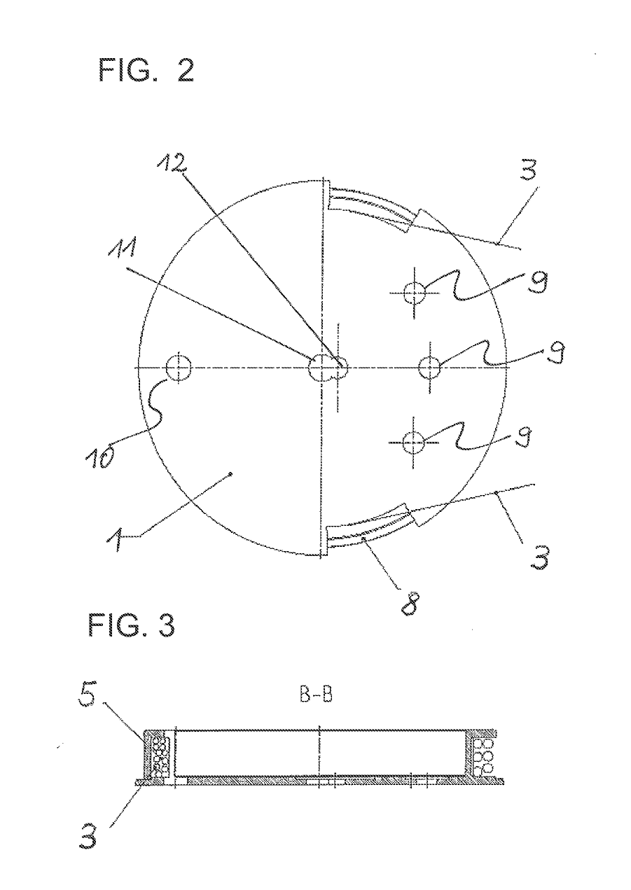

FIG. 2 shows a side view of the housing shown in FIG. 1, as radial section, and

FIG. 3 shows an axial section through the housing shown in FIG. 1.

FIG. 1 shows one exemplary embodiment of the housing 1 for glass-fiber-based optical waveguides. The winding slot 2 was formed by the housing 1 itself and a flange 6, which is fitted to each side of the housing.

The profiled rings 4 on the insides of the flanges 6, which form the winding slot 2, have a profile which on the one hand allows a clamping ring 5 to rest on it, while on the other hand locking the clamping ring 5 in a desired position: the clamping ring 5 is adjusted such that the cutouts 7 on the clamping ring 5 are located directly above the cutouts in the flange 6 of the housing 1. This prevents the fiber from being trapped in a fiber outlet opening 8.

Furthermore, FIG. 1 shows that the clamping ring 5 can be connected in captive manner to the housing 1 via a flexible connection 13.

FIG. 2 shows the housing 1 with the profile of a side boundary ring, which contains cutouts for the optical waveguide fiber to be passed out of.

The holes 9 offer individual possible ways to attach the housing to the assembly, to the appliance or to mount it in a rack.

The hub 11 is located centrally and can be used as a holder for a shaft, in particular when the intention is to wind the optical waveguide 3 up by machine. An additional outward bulge 12 on the hub opening can be used to allow an appropriately designed drive apparatus on a shaft to drive the spool housing 1.

An additional spacing bolt hole 10 in the housing 1 can be used as a holder for the winding spacing bolt (not illustrated). The spacing bolt is plugged into the spool before the fiber is wound up, and acts as a larger winding radius at this point. After the fiber has been wound up, the bolt can be removed, leading to a tension-free fiber winding. The tension-free fiber winding therefore allows simple adaptation of the fiber length projecting out of the housing, simply by pulling out the fiber or conversely, pushing the fiber into the winding slot. This allows the fiber length projecting out of the housing to be matched in simple manner to the respectively required length.

FIG. 3 shows the axial section through the housing 1 with an inserted clamping ring 5. The optical waveguides 3 (for example erbium fibers) are in this case located loosely in the winding slot 2.

### LIST OF SYMBOLS

1. Housing
2. Winding slot
3. Optical waveguide
4. Profiled ring
5. Clamping ring
6. Flange
7. Cutout
8. Fiber outlet opening
9. Mounting hole
10. Spacing bolt hole
11. Hub
12. Outward drive bulge
13. (Flexible) connection

1-12. (canceled)

13. A housing for an optical waveguide, which comprises:
the housing having a winding slot formed therein.

14. The housing according to claim 13, formed with a spacing bolt bore for a removable spacing bolt.

15. The housing according to claim 14, wherein said spacing bolt bore is configured such that a spacing bolt that has been inserted into said spacing bolt bore projects into said winding slot.

16. The housing according to claim 13, wherein said winding slot is configured to allow the optical waveguide can be wound up therein substantially without any pressure or tension.

17. The housing according to claim 13, which further comprises a slot cover for closing said winding slot.

18. The housing according to claim 17, wherein said slot cover is a clamping ring.

19. The housing according to claim 18, wherein said clamping ring and said housing are integrally formed in one piece.

20. The housing according to claim 11, wherein said housing and said slot cover are integrally formed in one piece.

21. The housing according to claim 13, wherein said housing is formed with a base area having a hub fitted substantially centrally thereon, and wherein said hub is configured for plugging the housing onto a shaft.

22. The housing according to claim 21, wherein said hub is formed with an outward drive bulge for rotation of said housing.

23. The housing according to claim 13, formed with at least one side outlet opening for guiding the optical waveguide.

24. The housing according to claim 13, comprising at least one mounting device.

25. The housing according to claim 24, wherein said mounting device includes at least one mounting hole (9).

26. A method for tension-free accommodation of an optical waveguide in a housing, comprising: disposing an optical wave in a housing with a fiber length projecting out of the housing, wherein the fiber length projecting out of the housing can be matched in a simple manner to the respectively required length.
